(19) United States
(12) Patent Application Publication
(10) Pub. No.: US 2016/0060906 A1
(43) Pub. Date: Mar. 3, 2016

(54) Bolt Retention System for a Safe

(71) Applicant: John D. Brush & Co., Inc., Rochester, NY (US)

(72) Inventors: Raymond J. Stein, Canandaigua, NY (US); Mark D. Perkins, Wayland, NY (US)

(73) Assignee: John D. Brush & Co., Inc., Rochester, NY (US)

(21) Appl. No.: 14/474,913

(22) Filed: Sep. 2, 2014

(51) Int. Cl. E05B 65/00; E05C 1/08

(52) U.S. Cl. CPC E05B 65/0082; E05C 1/08

(57) ABSTRACT

A locking bolt retaining mechanism for a safe is provided. The safe includes a door pivotally coupled with an enclosure housing, at least one locking bolt, a lock actuator operationally connected with the locking bolt to move it between extended and retracted positions, and a lock for preventing the lock actuator from moving the locking bolt to the retracted position. The bolt retaining system comprises a bracket guide including a guide member and an engagement member coupled to the door, and a bracket arm connected to the locking bolt. The bracket arm is slidably disposed between the guide member and engagement member of the bracket guide. Upon occurrence of an engagement event, the bracket arm engages the engagement member of the bracket guide to prevent the locking bolt from moving from the extended position thereby preventing disengagement of the locking bolt from the at least one bolt receiving aperture.

### BACKGROUND OF THE INVENTION

The present invention generally relates to a bolt retention system for a safe; more particularly, the bolt retention system operates to prevent unwanted disengagement of a bolt mechanism that is used to selectively secure a door to an enclosure housing when a bottom portion of the safe is subjected to impact, such as from falling from an elevated surface, particularly when the structural integrity of the safe has been compromised due to exposure to fire and/or water damage.

One purpose of a safe is to prevent unauthorized access to an interior compartment where valuables or other items may be stored. Some types of safes have fire-resistant attributes and typically are rated for integrity over a specific exposure temperature and/or time. These types of safes are known as fire-resistant safes and are widely used for storage of documents or other valuables which may be damaged or destroyed by exposure to high temperatures and/or water during a fire and other disastrous acts of nature. For example, various models of such fire-resistant safes are available from Sentry Group, Rochester, N.Y. 14625 USA.

A typical fire-resistant safe includes an enclosure housing and a door that define an interior storage compartment therebetween for storing valuables or other items. In order to provide selective access to the interior storage compartment of the safe, the door may be hingedly coupled with the enclosure housing, wherein the door is configured to move between opened and dosed positions to selectively permit access through an access opening defined in the enclosure housing. The ability to move the door from the dosed position to the opened position is typically controlled by a lock, such as, for example, a combination lock, a keyed lock, or an electromagnetically driven lock, that may operate in conjunction with a bolt mechanism, which includes one or more bolts, that are slidably mounted to the door and configured to selectively engage corresponding recesses formed in a door jamb of the enclosure housing.

In some types of fire-resistant safes, both the door and enclosure housing are hollow, having at least one of inner and outer shells which may be formed by an injection molding process or other known forming means. Injection molding is a well-known technique for forming articles from thermoplastic resins. The interior space between the inner and outer shells is filled with a non-combustible, fire-proof thermally-insulating material such as hydrated Portland cement. Notably, the inner shells are formed of polymeric resin having a melting point higher than the boiling point of water such that the hydration prevents the inner shells from melting, or igniting, for an extended period of time. Although being constructed of thermoplastic resins selected to provide adequate fire resistance for a prolonged period of time (in some cases up to 2 hours at about 1000° C.), these resins may become soft, pliable or otherwise compromised due to exposure to elevated temperatures during a fire. Impact to the softened thermoplastic resin due to, for example, the enclosure falling from an elevated surface, could potentially lead to a breach of the safe's fire resistance and allow access to the internal storage compartment. In particular, impact to the bottom portion of the enclosure housing may impart an upward force to the bolt mechanism. Sufficient impact may cause one or more bolts to become dislodged from the corresponding recesses defined in the door jamb of the enclosure housing, thereby allowing at least a portion of the door to open, and in a worst case scenario, all of the bolts would become dislodged and the safe door would be free to swing open on its hinge. Breaching the safe door allows flame, smoke and/or water to enter the interior safe compartment and damage or destroy the items stored therein.

Accordingly, there exists a need for a safe that is configured to prevent unwanted disengagement of the bolt mechanism when a bottom portion of the safe is subjected to impact, such as from falling from an elevated surface, particularly when the structural integrity of the safe has been compromised due to exposure to fire and/or water. The present invention fills these, as well as other, needs.

### SUMMARY OF THE INVENTION

The present invention is directed to a bolt retention system for a safe, such as, for example, a fire-resistant safe. The safe comprises an enclosure housing, a door, at least one locking bolt, a lock actuator, and a lock. The enclosure housing includes an access opening defined therein, wherein the enclosure housing includes at least one bolt receiving aperture defined therein. The door is pivotally coupled with the enclosure housing and configured for being moved between an opened position and a closed position. The door is configured for being received within the access opening when in the closed position. The at least one locking bolt is moveably secured to the door and configured for moving between extended and retracted positions to secure the door to, and release the door from, the enclosure housing, respectively. Further, the at least one locking bolt is configured for being positioned within the at least one bolt receiving aperture in the enclosure housing when in the extended position to secure the door to the enclosure housing. The lock actuator is operationally connected with the at least one locking bolt to move the at least one locking bolt between the extended and retracted positions. The lock is connected to the door and configured for selectively preventing the lock actuator from moving the at least one locking bolt to the retracted position.

In one aspect, the bolt retention system includes a bracket guide and a bracket arm. The bracket guide includes a guide member and an engagement member coupled to the door. The bracket arm is connected to the at least one locking bolt, and is slidably disposed between the guide member and the engagement member of the bracket guide as the at least one bolt is moved between extended and retracted positions. The engagement member of the bracket guide is configured for engaging the bracket arm upon occurrence of an engagement event to prevent the at least one locking bolt from moving from the extended position toward the retracted position, thereby preventing disengagement of the at least one locking bolt from the at least one bolt receiving aperture. At least a portion of the engagement member moves in an impact direction upon the occurrence of the engagement event thereby causing the engagement member to impact and mechanically engage the bracket arm. The impact direction may be, for example, perpendicular to a direction that the at least one bolt moves between extended and retracted positions. The engagement event may be an impact to the safe after a fall from an elevated surface or other event that imposes a force to the bottom portion of the safe.

In another aspect, the safe used in conjunction with the bolt retention system may include a bolt bracket, wherein the at least one locking bolt includes a plurality of locking bolts, and wherein the bolt bracket connects the plurality of locking bolts together. In the instance where a bolt bracket is used, the bolt bracket is coupled with the bracket arm so that the one or more locking bolts are operationally connected to the bracket arm via the bolt bracket. Further, the bracket arm may be disposed adjacent to or in association with one of the plurality of locking bolts disposed closest to a bottom edge of the door.

In yet another aspect, the bracket arm includes an upper surface and a lower surface, wherein the lower surface includes one or more engagement features defined therein, such as, for example, teeth, to facilitate the mechanical engagement of the bracket arm with the bracket guide upon occurrence of an impact caused by an engagement event. The upper surface is slidably disposed against the guide member of the bracket guide, and the one or more engagement features are disposed adjacent to the engagement member of the guide bracket when the at least one locking bolt is in the extended position.

In a further aspect, the engagement member of the bracket guide may include a plurality of structural webbing members that are connected to one another by at least one lateral wall. The plurality of structural webbing members may be positioned so they are in alignment with the space between each of the engagement features defined in the bracket arm when the at least one locking bolt is in the extended position. Further, the plurality of structural webbing members may be disposed adjacent to, or extend from, a bottom edge of the door so that they can facilitate the transfer the force imposed by the impact to cause the lateral wall of the engagement member to engage the bracket arm to prevent the one or more locking bolts from moving from the extended position.

In yet another aspect, the bolt retention system may further include a lock reinforcement structure extending outwardly from an interior surface of the door, wherein the lock reinforcement structure disposed adjacent to the lock.

In another aspect, a locking bolt retaining system for a safe is provided. The safe includes a door pivotally coupled with an enclosure housing, the safe including at least one locking bolt slidably coupled with the door and configured for moving between extended and retracted positions to selectively lock and unlock the door with the enclosure housing. The locking bolt retaining system comprises a bracket guide including a guide member and an engagement member coupled to the door. The locking bolt retaining system further includes a bracket arm connected to the at least one locking bolt. The bracket arm is slidably disposed between the guide member and the engagement member of the bracket guide. The bracket arm including an upper surface and a lower surface, wherein the upper surface is slidably positioned adjacent to the guide member, and wherein the lower surface including an engagement feature positioned adjacent to the engagement member of the bracket guide. The engagement member of the bracket guide is configured for engaging the engagement feature of the bracket arm upon occurrence of an engagement event to prevent the at least one locking bolt from moving from the extended position thereby preventing the door from unlocking from the enclosure housing.

Additional objects, advantages and novel features of the present invention will be set forth in part in the description which follows, and will in part become apparent to those in the practice of the invention, when considered with the attached figures.

### BRIEF DESCRIPTION OF THE DRAWINGS

The accompanying drawings form a part of the this specification and are to be read in conjunction therewith, wherein like reference numerals are employed to indicate like parts in the various views, and wherein:

FIG. 1 is a front perspective view showing a safe including an enclosure housing and a door in an opened position;

FIG. 2 is a front perspective view of the enclosure housing shown in FIG. 1 with the door removed to show a plurality of bolt apertures defined therein;

FIG. 3 is a front elevation view of an interior side of the door shown in FIG. 1 including a bolt retention system in accordance with an aspect of the present invention, wherein the locking bolts are shown in an extended position;

FIG. 4 is a perspective view of the bolt retention system shown in FIG. 3; and

FIG. 5 is a front elevation view of the interior side of the door shown in FIG. 3 except that the locking bolts are in a retracted position; and

FIG. 6 is an enlarged view of the bolt retention system labeled as “6” in FIG. 4.

### DETAILED DESCRIPTION OF THE INVENTION

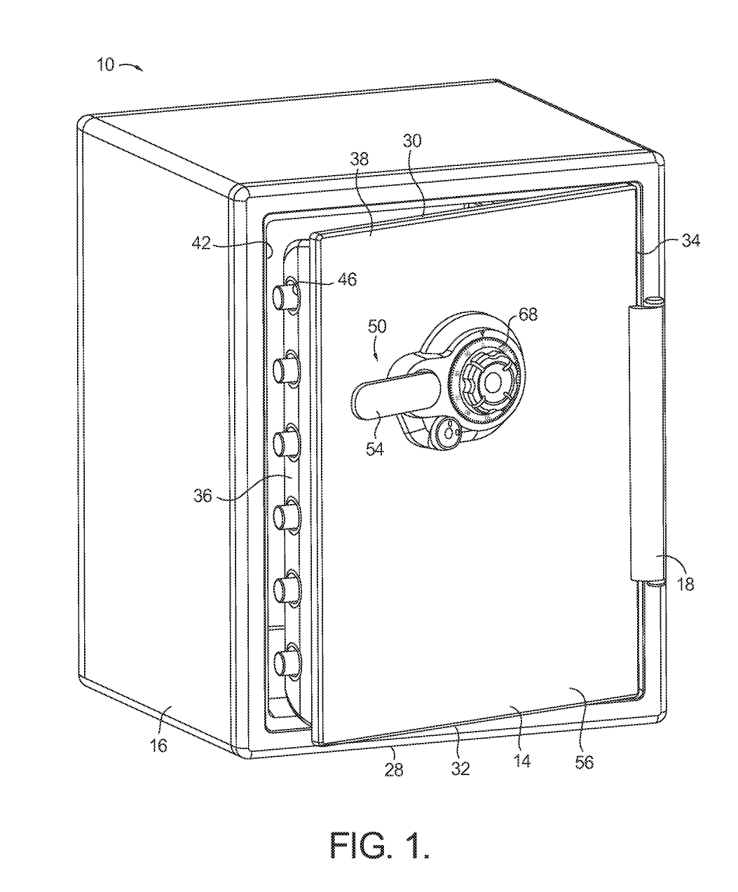

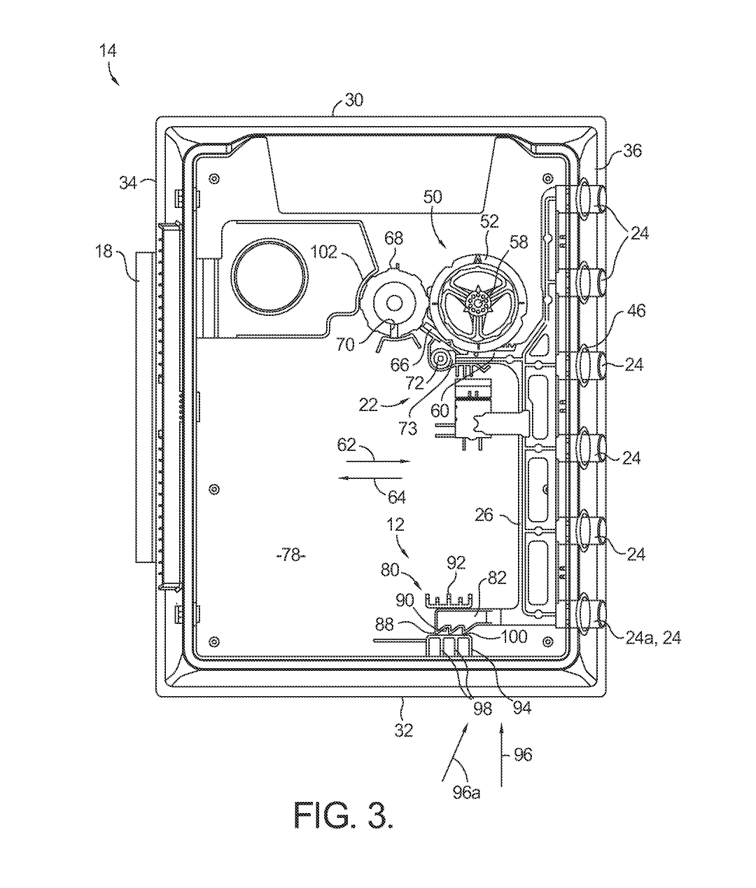

Referring now to the drawings in detail, and specifically to FIGS. 1 and 3, reference numeral 10 designates a safe that includes a bolt retention system 12 in accordance with an aspect of the present invention. In general, safe 10 may include a door 14 pivotally coupled with an enclosure housing 16 about a hinge 18, wherein door 14 is configured for selectively moving between opened and dosed positions to allow and restrict access to an interior storage compartment 20. Interior storage compartment 20 is an area in which valuables and other items may be stored and secured when door 14 is in the dosed position. A lock mechanism 22 is selectively operated to secure door 14 to enclosure housing 16 in the dosed position using a bolt mechanism, which may include one or more locking bolts 24 and a bolt bracket 26. The one or more bolts 24 are in turn securely held in a locked position by bolt retention system 12 to prevent unwanted disengagement of the one or more bolts 24 when a bottom portion 28 of enclosure housing 16 is subjected to an impact, such as from falling from an elevated surface, particularly when the structural integrity of safe 10 has been compromised due to exposure to fire and/or water. While the description set forth herein refers to a fire-resistant safe, it should be understood that the following description may be adapted for use with other style safes or security enclosures, such as but not limited to top loading chests, lock boxes, floor safes, wall safes, file cabinets and the like.

In particular, with reference to FIGS. 1, 3 and 4, door 14 generally includes a top edge 30 and opposing bottom edge 32, and a hinge edge 34 and opposing engagement edge 36. When constructed as a fire-resistant safe, door 14 may further include, for example, a spaced apart outer steel wall 38 and an injection molded inner wall 40. A fire-resistant insulation material is positioned within at least a portion of the open space defined between the inner and outer walls 38, 40 to protect the contents located within interior storage compartment 20 from fire and/or water damage. Hinge edge 34 includes hinge 18 that is configured for pivotally attaching door 14 to enclosure housing 16. In this manner, door 14 may be selectively pivoted between the closed position, wherein an access opening 42 of enclosure housing 16 is secured, to an opened position, wherein interior storage compartment 20 is accessible through access opening 42.

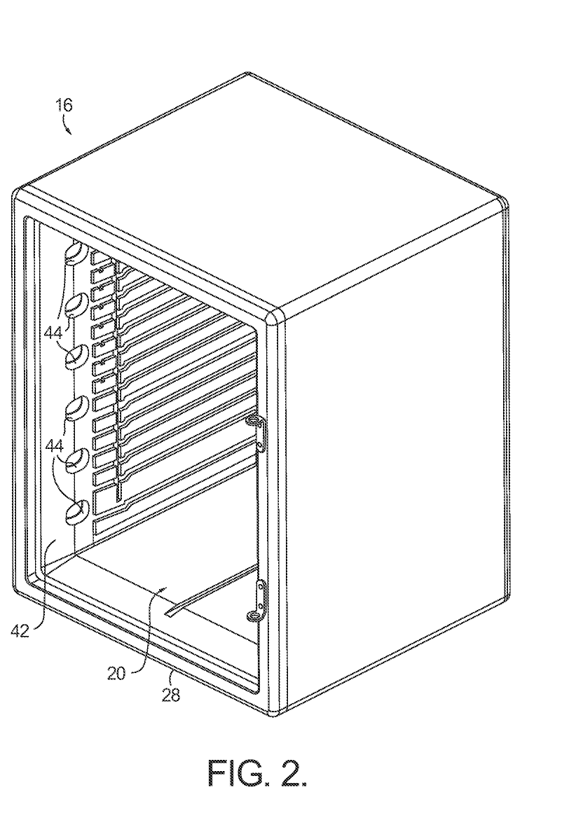

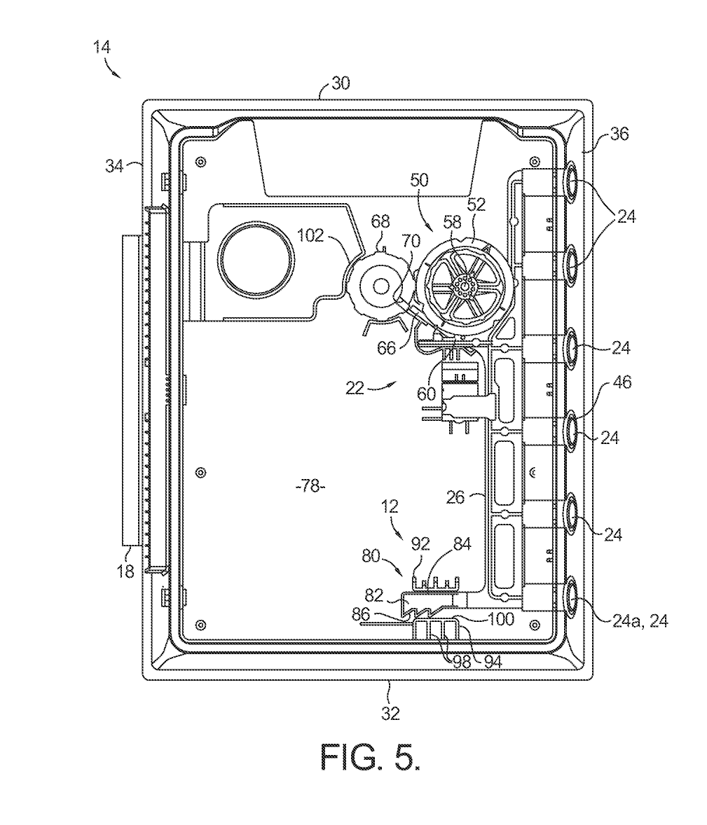

As best seen in FIGS. 1-5, engagement edge 36 is positioned opposite of hinge edge 34 and has one or more locking bolts 24 configured to be selectively positioned in locked (extended)(FIGS. 1, 3, 4, 6) and unlocked (withdrawn)(FIG. 5) positions with respect to corresponding bolt recesses 44 defined in access opening 42 of enclosure housing 16. Bolts 24 are used to selectively secure door 14 to enclosure housing 16. Further, bolts 24 may be slidably positioned within corresponding bolt apertures 46 defined in engagement edge 36 and moved between the locked and unlocked positions. Also, bolts 24 may be connected to common longitudinally-oriented bolt bracket 26 so that all of bolts 24 move in conjunction with one another during the locking and unlocking process. The bolts 24, along with bolt bracket 26, may be selectively moved between the locked and unlocked positions using a lock actuator 50. One example of a suitable lock actuator 50 is a rotating gear 52 driven by a handle 54 extending from an exterior surface 56 of door 14, wherein handle 54 rotates along with a spindle 58 to selectively drive bolts 24. Gear 52 includes a plurality of teeth that are configured to mesh with corresponding teeth on a bracket rack 60 that is connected to bolt bracket 26. Rotation of gear 52 translates bracket rack 60, thus laterally translating bolt bracket 26, and in turn bolts 24, either in an outward direction 62 or inward direction 64 depending on the rotational direction that handle 54 is turned.

To provide the requisite security, locking mechanism 22 further includes a fence 66 and a lock 68, such as, for example, a tumbler stack, that control whether lock actuator 50 can be used to retract or extend bolts 24. In particular, the teeth on gear 52 are meshed with corresponding teeth formed in fence 66, whereby fence 66 translates upon actuation of spindle 58 via handle 54. Fence 66 is configured to interact with lock 68 to determine whether handle 54 and spindle 58 can be rotated. Lock 68 has a slot 70 defined therein that is adapted to receive fence 66 when lock 68 is in an unlocked state. For example, lock 68 may be a combination lock having two or more slotted rotating discs, wherein the individual disc slots coincide with one another upon the proper input of lock 68. When the proper combination is set by a user, slot 70 is arranged to accept insertion of fence 66 which in turn allows actuation of gear 52 to fully withdraw bolts 24 from their respective bolt recesses 44 in enclosure housing 16. In all other instances where the lock combination is incorrect, slot 70 (for instance, at least one or more of disc slots on the combination lock 68) does not align with fence 66. In this instance, actuation of gear 52 translates fence 66 until fence 66 impacts the body of lock 68 and can translate no further. As a result of this incomplete translation of fence 66, bolts 24 cannot be completely withdrawn from their respective recesses 44 in enclosure housing 16 thereby securing door 14 in a locked position.

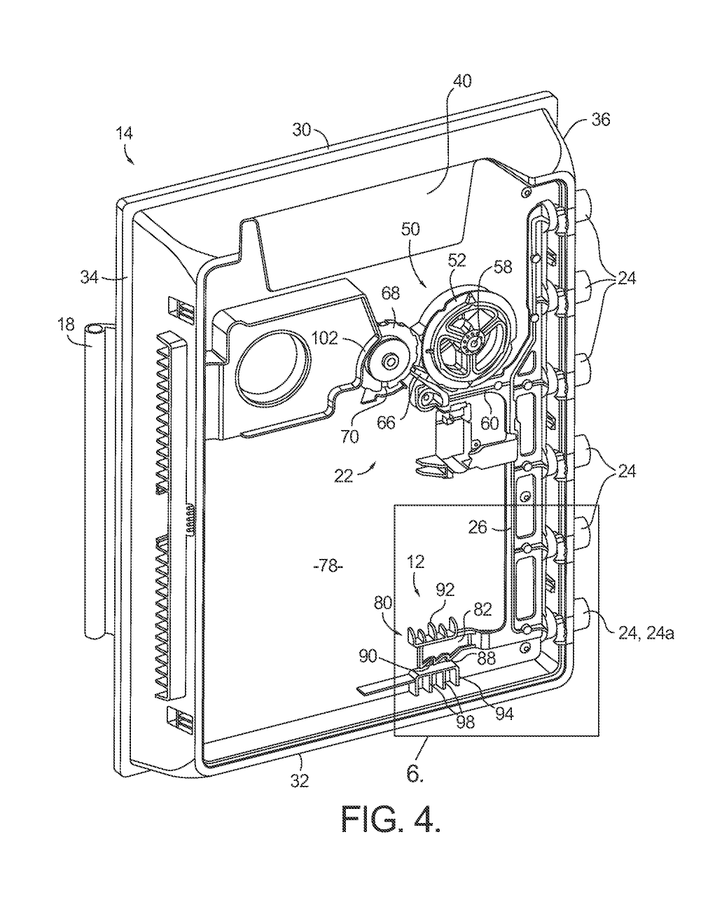

As best seen in FIG. 3, locking mechanism 22 may further include a secondary key 72 that operates to rotate a dog 73 between locked and unlocked positions. In the locked position, dog 73 is positioned adjacent to bracket 60 so that gear 52 cannot be used to move bolts 24 to the retracted position. Secondary key 72 can be operated to rotate dog 73 to the unlocked position so that dog 73 does not prevent gear 52 from rotating bolts 24 to the retracted position. To prevent unnecessary and unwanted over-translation of bolts 24 when moving bolts 24 to the fully retracted position, bolt bracket 26 is configured to contact gear 52. It should be understood that inner surface 78 of door 14 shown in FIGS. 3 and 4 refers to the surface in which the relevant components shown therein are attached to door 14, and that a cover (no shown) may be disposed over these components so that the user of the safe does not have easy access to the components. It should be understood that inner surface 78 does not relate to such a cover.

As discussed above, door 14 may be fabricated at least in part by injection molding of a thermoplastic resin. Such fire-resistant safe doors may be susceptible to failure of its fire resistance if safe 10 (with door 14 in the locked position) is subjected to a prolonged and/or extremely high temperature fire and experiences a fall or drop. For instance, safe 10 may be located on an upper story floor. During a fire, the floor may become weakened or destroyed and safe 10 may fall from this upper story to the story below. The safe bottom 28 is then subjected to a jarring impact when striking the below surface. Such an impact on the softened thermoplastic resin of safe 10 may cause door 14 to shift such that one or more bolts 24 become dislodged from enclosure housing 16. Once dislodged, fire, smoke and/or water may enter interior storage compartment 20 and damage or destroy the stored items. In a worst case scenario, all of the bolts 24 become dislodged from safe 10 thereby allowing door 14 to freely open. In this scenario, not only are the safe's contents exposed to fire, smoke and/or water, the contents are further unsecured meaning that an unscrupulous individual could simply take the unsecured contents.

In accordance with an aspect of the present invention, bolt retention system 12 is provided to prevent door 14 from becoming disengaged from the dosed position upon the occurrence of an engagement event. The engagement event could be an instance where safe 10 falls from an elevated surface during the normal use or storage of the safe, during or after a fire, or during another event that imposes a force on bottom portion 28 of safe 10 that is translated to a bottom portion of door 14 near bottom edge 32.

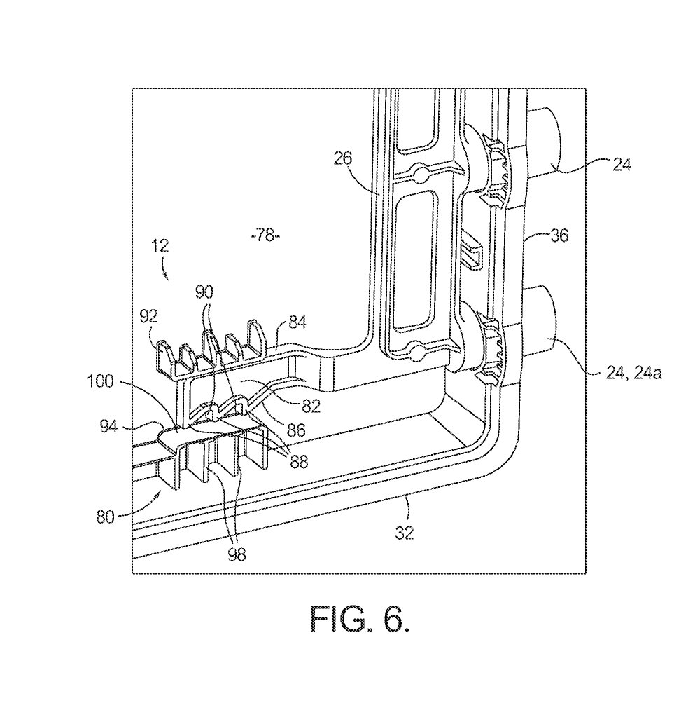

With reference to FIGS. 3-6, bolt retention system 12 comprises a bracket guide 80 and a bracket arm 82. Bracket guide 80 is secured to, and extends outwardly from, inner surface 78 of door 14. Bracket arm 82 is configured to slidably travel in directions 62, 64 within bracket guide 80 as bolts 24 are moved between locked (FIGS. 3, 4, 6) and unlocked (FIG. 5) positions by the actuation of gear 52. In one aspect, bracket arm 82 may be connected to bolt bracket 26 which is in turn connected to two or more bolts 24. More particularly, bracket arm 82 may be connected to bolt bracket 26 in a location associated with a bolt 24a positioned closest to bottom edge 32 of door 14. In another aspect, in the instance that only a single bolt is used to secure door 14 to enclosure housing 16, bracket arm 82 may be connected to bolt 24 without the use of bolt bracket 26. As best seen in FIG. 6, bracket arm 82 further includes an upper surface 84 and a lower surface 86. Lower surface 86 includes one or more engagement feature 88 and corresponding voids 90 (e.g., peaks and valleys) defined therein, such as one or more teeth, that are positioned adjacent to bracket guide 80 when the bolts 24 are in the locked position.

As best seen in FIGS. 3, 5 and 6, bracket guide 80 includes a top guide member 92 and a lower engagement member 94 spaced apart from one another a distance that allows bracket arm 82 to be slidably positioned therebetween. Top guide member 92 extends outwardly from inner surface 78 of door 14. When bolts 24 are in a locked (extended) position, as shown in FIGS. 3, 4 and 6, upper surface 84 of bracket arm 82 is slidably positioned adjacent to top guide member 92, and engagement features 88 are positioned adjacent to lower engagement member 94. Top guide member 92 is disposed above bracket arm 82 and is configured to remain in a fixed position such that bracket arm 82 is prevented from moving upwardly when an impact is imposed directly, or indirectly through bottom portion 28 of enclosure housing 16, on bottom edge 32 of door 14 in an impact direction 96. It should be understood that the impact direction 96 may be perpendicular to the locking and unlocking direction 62, 64 of bolts 24, or may be at an angle 96a relative to directions 62, 64, wherein a sufficient amount of the force experienced by safe 10 is directed to bottom edge 32 to dislodge one or more bolts 24.

While top guide member 92 is configured to prevent upward travel of bracket arm 82, lower engagement member 94 is configured to engage with engagement feature 88 on bracket arm 82 upon occurrence of an impact event to prevent movement of bracket arm 82 in unlock direction 64. This arresting of movement of bracket arm 82 in the unlock direction 64 also arrests any movement of one or more bolts 24 in unlock direction 64 thereby securing bolts 24 within their respective recesses 44 within enclosure housing 16. In this manner, door 14 is secured from unwanted opening and the associated failure of the safe's fire resistance due to an impact such as described above.

In accordance with an aspect of the present invention, lower engagement member 94 may be configured to include a plurality of structural webbing members 98 that are connected by at least one lateral wall 100. During normal operation of safe 10, as best seen in FIGS. 3 and 5, lateral wall 100 provides a lower surface upon which bracket arm 82 may be guided as bolts 24 move between locked and unlocked positions. As best seen in FIG. 6, structural webbing members 98 may extend perpendicularly from bottom edge 32 toward top guide member 92 so that lateral wall 100 is positioned a distance from top guide member 92 that will allow bracket arm 82 to be slidingly received therebetween. Structural webbing members 98 are positioned so they are in alignment with the space between each of the engagement features 88, and therefore generally coincident with voids 90 defined by bracket arm 82. The relative position of engagement features 88 and structural webbing members 98 allow engagement features 88 to impinge upon lateral wall 100, or cause lateral wall 100 to deform around engagement features 88, while structural webbing members 98 translate into voids 90 in response to the upward movement 96 of bottom edge 32 of door 14. The impingement or deformation of lateral wall 100 by engagement features 88 operates to mechanically engage the bracket arm 82 to lower engagement member 94 to prevent bolts 24 from moving from the locked position upon occurrence of an engagement event.

While the above-referenced aspect described bracket arm 82 as including engagement features 88 and voids 90 that operate to engage the lower engagement member 94 of bracket guide 80, it should be understood that it is also contemplated that the lower engagement member 94 include engagement features and voids that operate to engage a bracket arm that includes the structural webbing members and lateral wall as described above to arrest the movement of bolts 24 when in the locked position during an engagement event.

In a further aspect of the present invention, and as best seen in FIGS. 3-5, door 14 may optionally include a lock reinforcement structure 102 configured to prevent unwanted movement of locking mechanism 22 in direction 64, such as when door 14 is subjected to an impact in direction 64. Lock reinforcement structure 102 extends outwardly from interior surface 78 of door 14 and is positioned adjacent to one or more components of locking mechanism 22, for example, lock 68. Thus, taking the example of door 14 as shown in FIG. 3, lock reinforcement structure 102 secures lock 68 from unwanted movement. In this manner, door 14 remains securely closed to enclosure housing 16, thereby preserving the fire resistance of safe 10 and protecting the items located within interior storage compartment 20. It should be understood that the position and/or configuration of lock reinforcement structure 102 may be modified depending on the type of lock 68 used in association with door 14.

The foregoing description of the preferred embodiment of the invention has been presented for the purpose of illustration and description. It is not intended to be exhaustive nor is it intended to limit the invention to the precise form disclosed. It will be apparent to those skilled in the art that the disclosed embodiments may be modified in light of the above teachings. The embodiments described are chosen to provide an illustration of principles of the invention and its practical application to enable thereby one of ordinary skill in the art to utilize the invention in various embodiments and with various modifications as are suited to the particular use contemplated. Therefore, the foregoing description is to be considered exemplary, rather than limiting, and the true scope of the invention is that described in the following claims. For instance, while the above discussion is directed toward a fire-resistant safe, it should be understood that this discussion is exemplary in nature and that the bolt retention system of the present invention may be modified to accommodate different types of non fire-resistant safes that utilize one or more locking bolts to secure a door to an enclosure housing. These modifications are to be considered within the scope of the present invention.

1. A safe comprising:
an enclosure housing having an access opening defined therein, the enclosure housing including at least one bolt receiving aperture;
a door pivotally coupled with the enclosure housing and configured for being moved between an opened position and a dosed position, the door is configured for being received within the access opening when in the dosed position;
at least one locking bolt moveably connected to the door and configured for moving between extended and retracted positions to secure the door to, and release the door from, the enclosure housing, respectively, wherein the at least one locking bolt is configured for being positioned within the at least one bolt receiving aperture in the enclosure housing when in the extended position to secure the door to the enclosure housing;
a lock actuator operationally connected with the at least one locking bolt to move the at least one locking bolt between the extended and retracted positions;
a lock connected to the door and configured for selectively preventing the lock actuator from moving the at least one locking bolt to the retracted position;
a bracket guide including a guide member and an engagement member coupled to the door; and
a bracket arm connected to the at least one locking bolt, the bracket arm slidably disposed between the guide member and the engagement member of the bracket guide,
wherein the engagement member of the bracket guide engages the bracket arm upon occurrence of an engagement event to prevent the at least one locking bolt from moving from the extended position thereby preventing disengagement of the at least one locking bolt from the at least one bolt receiving aperture.

2. The safe in accordance with claim 1, further comprising a bolt bracket, wherein the at least one locking bolt includes a plurality of locking bolts, wherein the bolt bracket connects the plurality of locking bolts together, and wherein the bolt bracket is coupled with the bracket arm.

3. The safe in accordance with claim 2, wherein the bracket arm is disposed adjacent to one of the plurality of locking bolts disposed closest to a bottom edge of the door.

4. The safe in accordance with claim 1, wherein the guide member extends outwardly from an inner surface of the door.

5. The safe in accordance with claim 1, wherein the bracket arm includes an upper surface and a lower surface, wherein the lower surface includes one or more engagement features defined therein.

6. The safe in accordance with claim 5, wherein the upper surface is slidably disposed against the guide member of the bracket guide, and wherein the one or more engagement features are disposed adjacent to the engagement member of the guide bracket when the at least one locking bolt is in the extended position.

7. The safe in accordance with claim 6, wherein the engagement member of the bracket guide includes a plurality of structural webbing members that are connected to one another by at least one lateral wall.

8. The safe in accordance with claim 7, wherein the plurality of structural webbing members are positioned so they are in alignment with the space between each of the engagement features defined in the bracket arm when the at least one locking bolt is in the extended position.

9. The safe in accordance with claim 8, wherein the plurality of structural webbing members are disposed adjacent to a bottom edge of the door.

10. The safe in accordance with claim 9, wherein each of the plurality of structural webbing members extend from a bottom edge of the door.

11. The safe in accordance with claim 1, wherein the engagement member moves in an impact direction upon the occurrence of the engagement event thereby causing the engagement member to impact the bracket arm.

12. The safe in accordance with claim 1, wherein the impact direction is perpendicular to a direction that the at least one bolt moves between extended and retracted positions.

13. The safe in accordance with claim 1, wherein the engagement event is an impact to the safe after a fall from an elevated surface.

14. The safe in accordance with claim 1, further comprising a lock reinforcement structure extending outwardly from an interior surface of the door, the lock reinforcement structure disposed adjacent to the lock.

15. A locking bolt retaining mechanism for a safe, the safe including an enclosure housing having an access opening defined therein, the enclosure housing including at least one bolt receiving aperture, a door pivotally coupled with the enclosure housing and configured for being moved between an opened position and a closed position, the door is configured for being received within the access opening when in the closed position, at least one locking bolt moveably connected to the door and configured for moving between extended and retracted positions to secure the door to, and release the door from, the enclosure housing, respectively, wherein the at least one locking bolt is configured for being positioned within the at least one bolt receiving aperture in the enclosure housing when in the extended position to secure the door to the enclosure housing, a lock actuator operationally connected with the at least one locking bolt to move the at least one locking bolt between the extended and retracted positions, and a lock connected to the door and configured for selectively preventing the lock actuator from moving the at least one locking bolt to the retracted position, the bolt retaining system comprising:
a bracket guide including a guide member and an engagement member coupled to the door; and
a bracket arm connected to the at least one locking bolt, the bracket arm slidably disposed between the guide member and the engagement member of the bracket guide,
wherein, upon occurrence of an engagement event, the bracket arm engages the engagement member of the bracket guide to prevent the at least one locking bolt from moving from the extended position thereby preventing disengagement of the at least one locking bolt from the at least one bolt receiving aperture.

16. The locking bolt retaining mechanism in accordance with claim 15, further comprising a bolt bracket, wherein the at least one locking bolt includes a plurality of locking bolts, wherein the bolt bracket connects the plurality of locking bolts together, and wherein the bolt bracket is coupled with the bracket arm.

17. The locking bolt retaining mechanism in accordance with claim 16, wherein the bracket arm is disposed adjacent to one of the plurality of locking bolts disposed closest to a bottom edge of the door.

18. The locking bolt retaining mechanism in accordance with claim 15, wherein the guide member extends outwardly from an inner surface of the door.

19. The locking bolt retaining mechanism in accordance with claim 15, wherein the bracket arm includes an upper surface and a lower surface, wherein the lower surface includes one or more engagement features defined therein.

20. The locking bolt retaining mechanism in accordance with claim 19, wherein the upper surface is slidably disposed against the guide member of the bracket guide, and wherein the one or more engagement features are disposed adjacent to the engagement member of the guide bracket when the at least one locking bolt is in the extended position.

21. The locking bolt retaining mechanism in accordance with claim 20, wherein the engagement member of the bracket guide includes a plurality of structural webbing members that are connected to one another by at least one lateral wall.

22. The locking bolt retaining mechanism in accordance with claim 21, wherein the plurality of structural webbing members are positioned so they are in alignment with the space between each of the engagement features defined in the bracket arm when the at least one locking bolt is in the extended position.

23. The locking bolt retaining mechanism in accordance with claim 22, wherein the plurality of structural webbing members are disposed adjacent to a bottom edge of the door.

24. The locking bolt retaining mechanism in accordance with claim 23, wherein each of the plurality of structural webbing members extend from a bottom edge of the door.

25. The locking bolt retaining mechanism in accordance with claim 15, wherein the engagement member moves in an impact direction upon the occurrence of the engagement event thereby causing the engagement member to impact the bracket arm.

26. The locking bolt retaining mechanism in accordance with claim 15, wherein the impact direction is perpendicular to a direction that the at least one bolt moves between extended and retracted positions.

27. The locking bolt retaining mechanism in accordance with claim 15, wherein the engagement event is an impact to the safe after a fall from an elevated surface.

28. The locking bolt retaining mechanism in accordance with claim 15, further comprising a lock reinforcement structure extending outwardly from an interior surface of the door, the lock reinforcement structure disposed adjacent to the lock.

29. A locking bolt retaining system for a safe, the safe including a door pivotally coupled with an enclosure housing, the safe including at least one locking bolt slidably coupled with the door and configured for moving between extended and retracted positions to selectively lock and unlock the door with the enclosure housing, the locking bolt retaining system comprising:
a bracket guide including a guide member and an engagement member coupled to the door; and
a bracket arm connected to the at least one locking bolt, the bracket arm slidably disposed between the guide member and the engagement member of the bracket guide, the bracket arm including an upper surface and a lower surface, the upper surface is slidably positioned adjacent to the guide member, the lower surface including an engagement feature positioned adjacent to the engagement member of the bracket guide,
wherein the engagement member of the bracket guide is configured for engaging the engagement feature of the bracket arm upon occurrence of an engagement event to prevent the at least one locking bolt from moving from the extended position thereby preventing the door from unlocking from the enclosure housing.
